(19) United States
(12) Patent Application Publication
(10) Pub. No.: US 2025/0132969 A1
(43) Pub. Date: Apr. 24, 2025

(54) SYSTEMS AND METHODS FOR PERFORMING ROOT CAUSE ANALYSIS

(71) Applicant: Telefonaktiebolaget LM Ericsson (publ), Stockholm (SE)

(72) Inventors: Chia-Cheng YEN, Dublin, CA (US); Wenting SUN, San Jose, CA (US)

(73) Assignee: Telefonaktiebolaget LM Ericsson (publ), Stockholm (SE)

(21) Appl. No.: 18/691,865

(22) PCT Filed: May 25, 2022
(86) PCT No.: PCT/IB2022/054932

§ 371 Date: Mar. 13, 2024

Related U.S. Application Data
(60) Provisional application No. 63/243,987, filed on Sep. 14, 2021.

(51) Int. Cl. H04L 41/0631; H04L 41/5009

(52) U.S. Cl. CPC H04L 41/065; H04L 41/5009

(57) ABSTRACT

A method for root cause analysis in a network comprising a set of nodes Ni for i=1 to N, where N>2. The method includes obtaining N sets of KPI data, each one of the N sets of KPI data being for one of the N nodes. The method also includes, for each one of the N nodes, using the set of KPI data associated with the node to generate feature vectors for the node. The method also includes generating relationship data using the feature vectors, the generated relationship data, indicating relationships between the nodes within the set of N nodes. The method also includes inputting to a GNN the generated relationship data and the feature vectors. The method also includes obtaining from the GNN information indicating that at least node Nj is a candidate root cause node and at least node Nk is a candidate victim node, where k≠j. The method further includes using the relationship data to i) determine whether to indicate the candidate root cause node Nj as a predicted root cause node and/or ii) determine whether to indicate the candidate victim node Nk as a predicted victim node.

### TECHNICAL FIELD

This disclosure relates to systems and method for performing root cause analysis.

### BACKGROUND

Given the advances in wireless communication technologies, such as, for example, 5G and New Radio (NR), it is expected that in the near future the number of devices using a wireless communication network will greatly increase. Maintaining such a large-scale network without any human intervention will require automatic root cause analysis (RCA) and fault localization (FL). Fault localization, which is a central aspect of network fault management, is a process of deducing the exact source of a failure from a set of observed failure indications (see, e.g., reference [1]). A failure in one part of a network could lead to other failures, propagate errors throughout a network, and eventually cause observable symptoms on the users' end. Such a failure is known as a “root cause.” RCA algorithms are designed to detect anomaly events within a network that could later cause observable symptoms on the users' end. Based on the observed symptoms, a series of failures caused by the source failure can be tracked back to the root cause.

RCA has been used in industries and a popular research topic in recent years. Its applications are widely applied to many scientific fields like chemical engineering and computer science. RCA combined with unsupervised learning is a promising solution to automatic root cause analysis and fault localization. RCA algorithms have been proposed to infer potential explanations/paths for root causes based on observed symptoms, and they can be implemented by a broad variety of well-known approaches. Existing approaches for RCA can be categorized into two branches: 1) Deterministic and 2) Non-deterministic (see, e.g. reference [2]).

In deterministic RCA, decision tree (DT) and support vector machine (SVM) are classic clustering algorithms where pre-defined rules/labels are usually obtained from given data (see, e.g. reference [3-7]). DT and SVM are applied to design clustering algorithms which can separate non-linear data. They have remarkable performance especially for high dimensional space. On the other hand, graph-based methods analyze root causes from another angle (see, e.g., references [8] and [9]). These methods build graphs where nodes denote services and edges indicate dependencies between services and hardware resources. Performance data is assigned to each edge associated with a service and its resources. Services with anomaly edges/performance, e.g., longer latency, are isolated from a graph. Later, root causes can be located along a path of the anomaly edges. Moreover, neural network based approaches can be regarded as powerful heuristic based clustering algorithms which are able to extract learnable features from a massive amount of data when labels are not available. (see, e.g., references [10] and [11]). Reference [11] proposed a graph neural network (GNN) based RCA algorithm for telecom networks. The time-series alarm data are used as node features and were fed into the GNN to train a RCA model. A GNN is a generalized form of Convolutional Neural Network (CNN) and is capable of handling the data with non-Euclidean structures such as social networks, telecom networks, and 3D images.

In non-deterministic RCA, bayesian networks (BNs) exploit conditional probabilities and wrap them into the priori knowledge stored in the tree-structured BNs (see, e.g., references [12-14]). A specific event that would happen depends only on its parent nodes, e.g., the probability that the event n would happen based the events m where m is n's parents. This branch of solutions can better deal with uncertainty and explore potential root causes by using conditional probabilities.

### REFERENCES

[1] M. Steinder, and A. S. Sethi. “A survey of fault localization techniques in computer networks.” Science of computer programming 53, no. 2 (2004): 165-194.
[2] M. Sold, V. Muntds-Mulero, A. I. Rana, and Giovani Estrada. “Survey on models and techniques for root-cause analysis.” arXiv preprint arXiv:1701.08546 (2017).
[3] M. Chen, A. X. Zheng, J. Lloyd, M. I. Jordan, and E. Brewer, “Failure diagnosis using decision trees,” in International Conference on Autonomic Computing, 2004. Proceedings. IEEE, 2004, pp. 36-43.
[4] A. P. Iyer, L. E. Li, and I. Stoica, “Automating diagnosis of cellular radio access network problems,” in Proceedings of the 23rd Annual International Conference on Mobile Computing and Networking, 2017, pp. 79-87.
[5] T. K. Ho, “Random decision forests,” in Proceedings of 3rd international conference on document analysis and recognition, vol. 1. IEEE, 1995, pp. 278-282.
[6] M. Demetgul, “Fault diagnosis on production systems with support vector machine and decision trees algorithms,” The International Journal of Advanced Manufacturing Technology, vol. 67, no. 9, pp. 2183-2194, 2013.
[7] F. Ye, Z. Zhang, K. Chakrabarty, and X. Gu, “Board-level functional fault diagnosis using multikernel support vector machines and incremental learning,” IEEE Transactions on Computer-Aided Design of Integrated Circuits and Systems, vol. 33, no. 2, pp. 279-290, February 2014.
[8] L. Wu, J. Tordsson, E. Elmroth, and O. Kao, “Microrca: Root cause localization of performance issues in microservices,” in NOMS 2020-2020 IEEE/IFIP Network Operations and Management Symposium. IEEE, 2020, pp. 1-9.
[9] J. Qiu, Q. Du, K. Yin, S.-L. Zhang, and C. Qian, “A causality mining and knowledge graph based method of root cause diagnosis for performance anomaly in cloud applications,” Applied Sciences, vol. 10, no. 6, p. 2166, 2020.
[10] M. Nauta, D. Bucur, and C. Seifert, “Causal discovery with attention-based convolutional neural networks,” Machine Learning and Knowledge Extraction, vol. 1, no. 1, pp. 312-340, 2019.
[11] J. He and H. Zhao, “Fault diagnosis and location based on graph neural network in telecom networks,” in 2020 International Conference on Networking and Network Applications (NaNA). IEEE, 2020, pp. 304-309.
[12] S. Dey and J. Stori, “A bayesian network approach to root cause diagnosis of process variations,” International Journal of Machine Tools and Manufacture, vol. 45, no. 1, pp. 75-91, 2005.
[13] B. Cai, L. Huang, and M. Xie, “Bayesian networks in fault diagnosis,” IEEE Transactions on Industrial Informatics, vol. 13, no. 5, pp. 2227-2240, 2017.
[14] A. Alaeddini and I. Dogan, “Using bayesian networks for root cause analysis in statistical process control,” Expert Systems with Applications, vol. 38, no. 9, pp. 11230-11 243, 2011.
[15] L. Bennacer, Y. Amirat, A. Chibani, A. Mellouk, and L. Ciavaglia. “Self-diagnosis technique for virtual private networks combining Bayesian networks and case-based reasoning.” IEEE Transactions on Automation Science and Engineering 12, no. 1 (2014): 354-366

### SUMMARY

Certain challenges presently exist. For example, existing RCA algorithms require both well-rounded domain knowledge and a certain level of human intervention, which may not be available in many real-world applications, especially for a large-scale network. For instance, clustering based RCA algorithms rely heavily on labels and perform well only for small datasets. As an example, RCA algorithms implemented by DT and SVM reveal significant performance on smaller datasets with well-defined labels and they usually require manual labelling and tuning for optimizing the algorithms, but, for large-scale networks, the amount of data generated is massive and often without any label data.

With respect to BN based RCA approaches, these approaches require a priori knowledge (conditional probabilities), which usually cannot be obtained from large-scale networks in real time. In many real-world applications, there is limited domain knowledge or no domain knowledge as a priori knowledge to assist in generating models. Also, BN based approaches are not suitable for large-scale networks because the computational complexity increases with the number of BN nodes (see, e.g., reference [15]).

Lastly, existing RCE algorithms are not capable of outputting accurate predicts as to the effects of a fault, but rather merely output some predicted root causes and/or possible explanations for the root causes.

This disclosure aims at mitigating the above problems. Accordingly, in one aspect there is provided a method for root cause analysis in a network comprising a set of nodes Ni for i=1 to N, where N>2. The method includes obtaining N sets of KPI data, each one of the N sets of KPI data being for one of the N nodes. The method also includes, for each one of the N nodes, using the set of KPI data associated with the node to generate feature vectors for the node. The method also includes generating relationship data using the feature vectors, the generated relationship data, indicating relationships between the nodes within the set of N nodes. The method also includes inputting to a graph neural network, GNN, the generated relationship data and the feature vectors. The method also includes obtaining from the GNN information indicating that at least node Nj is a candidate root cause node and at least node Nk is a candidate victim node, where k≠j. The method further includes using the relationship data to i) determine whether to indicate the candidate root cause node Nj as a predicted root cause node and/or ii) determine whether to indicate the candidate victim node Nk as a predicted victim node.

In another aspect there is provided a computer program comprising instructions which when executed by processing circuitry of an RCA agent causes the RCA agent to perform any of the methods disclosed herein. In one embodiment, there is provided a carrier containing the computer program wherein the carrier is one of an electronic signal, an optical signal, a radio signal, and a computer readable storage medium.

In another aspect there is provided an RCA agent that is configured to perform the methods disclosed herein. In some embodiments, the RCA agent comprises memory and processing circuitry coupled to the memory, wherein the memory contains instructions executable by the processing circuitry to configure the RCA agent to perform the methods disclosed herein.

An advantage of the embodiments disclosed herein is that they improve the prediction accuracy of root causes. Because the root causes can be predicted with better accuracy, catastrophic failures can be avoided before they happen and/or necessary actions, such as data backups, can be taken in advance to mitigate any damage. The embodiments are not only applicable in a communication network setting, but also apply to other fields, such as chemical engineering and industrial process control. In short, the embodiments, not only support state-of-the-art applications/services that requires robustness and reliability, but also reduce the need for valuable human resource to manually find faults, thereby saving a large amount of costs on maintaining a large network.

### BRIEF DESCRIPTION OF THE DRAWINGS

The accompanying drawings, which are incorporated herein and form part of the specification, illustrate various embodiments.

FIG. 1 illustrates a system according to some embodiments.

FIG. 2 is a flowchart illustrating a process according to some embodiments.

FIG. 3 illustrates an example graph.

FIG. 4 illustrates the output information produced by an RCA agent according to some embodiments.

FIG. 5 illustrates steps performed by a GNN according to some embodiments.

FIG. 6 illustrates the mapping of network nodes into a low dimensional space for separating the potential root cause nodes and the victim nodes.

FIG. 7 is a flowchart illustrating a process according to some embodiments.

FIG. 8 is a block diagram of RCA agent according to some embodiments.

### DETAILED DESCRIPTION

This disclosure provides an artificial intelligence (AI) based RCA agent that includes a graph neural network (GNN) to process graph-structured inputs with node features. In each iteration, for each node, the GNN aggregates data associated with the neighboring nodes to generate an embedding (i.e., a vector) for the node. Through training, the GNN learns how to map a node's features to an embedding space by optimizing neural parameters. The goal is to minimize the loss between predicted outcomes and ground truth labels. The embodiments disclosed herein are capable of: 1) minimizing the level of human intervention by parameterizing tunable features, 2) reducing dependency on a priori knowledge by using KPI data and node embeddings, and 3) increasing accuracy of predicting what would happen to a network by the proposed propagation path reconstruction refinement.

Graph-structured inputs can be formed by adding KPIs as node features. a GNN can be applied to these inputs to predict the potential root causes and explore possible propagation paths to mitigate the impact of failures for 5G networks.

The RCA agent is designed to discover potential root causes in systems. Many well-known algorithms use utilization data (e.g., CPU, memory, latency) for improving performance of RCA, but none of the work has taken KPI data (e.g., throughput, signal strength, channel quality, . . . etc) into account. This disclosure exploits the KPI data in a network environment and applies a GNN based RCA algorithm to predict any root cause and a chain of failures (victim nodes) led by it based on the pattern of the input features (KPIs) to further improve the prediction accuracy of root causes. Because the root causes can be predicted, catastrophic failures can be avoided before happening or necessary actions such as data backup can be taken in advance to mitigate the damage.

In the foreseeable future, many use-cases, such as enhanced Mobile Broadband (eMBB), Ultra Reliable Low Latency Communications (uRLLC), and mIoT (massive Internet of Things), can be fulfilled by 5G technologies. Users should be able to access services like autonomous vehicles, ultra-high resolution video streaming, or healthcare networks through their dedicated data bearers.

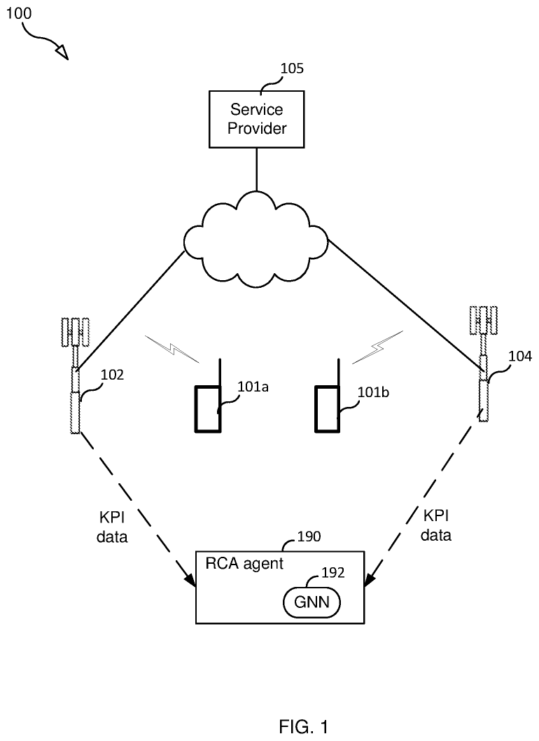

FIG. 1 illustrates a communication system 100 according to some embodiments. Communication system 100 includes network node 102 and 104, which, in this example are 5G base stations (a.k.a., “gNBs”). While only two network nodes are shown, it is known that communications system 100 may have hundreds or thousands of network nodes, or more. The gNBs in this example enable user equipments (UEs) 101a and 101b to consume services provided by different service providers (e.g., service provider 105). While only two UEs are shown, it is known that communications system 100 may have any number of UEs. As used herein a UE is any device capable of wireless communication with a base station such that the UE can establish a logical connection with the base station.

Each gNB in communication system 100 can concurrently serve multiple users for different applications using dedicated data bearers. Key performance indicators (KPIs) associated with a gNB reflect how well the gNB performs.

These KPIs include, for example: 1) Received Signal Strength Indicator (RSSI), 2) Reference Signal Received Power (RSRP), 3) Reference Signal Received Quality (RSRQ), 4) Signal-to-interference-plus-noise ratio (SINR) and 5) Throughput. RSRP and RSRQ are key measurements of signal level and quality for modem 5G networks. For example, in 5G networks, UEs move around from one gNB to another. These UEs, while being served by a particular gNB, measure signal strength and signal quality of neighboring gNBs before performing base station selection and hand-over. RSSI is a measurement of the power in a received radio signal. That is to say, how well a UE can hear a signal from a base station. It is a good indicator to determine whether there is enough signal to build a stable wireless connection. SINR is a quality measurement of a wireless connection. Throughput refers to a datarate, namely, how many bits can be delivered to a user per second. For example, 5G is capable of delivering up to tens of Gigabits-per-second (Gbps).

Communication system 100 also includes an RCA agent 190 that functions to employ a graph neural network (GNN) 192 to predict potential root causes and explore possible propagation paths to mitigate the impact of failures in the system 100.

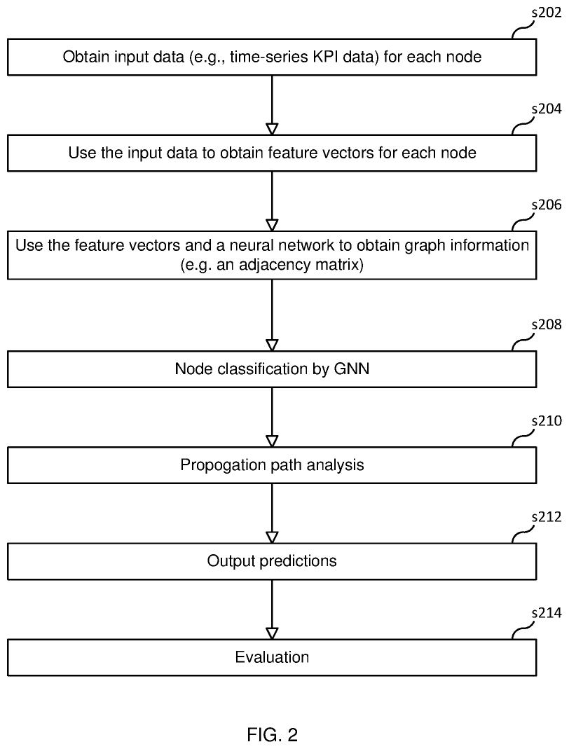

FIG. 2 illustrates steps that are performed by RCA agent 190 according to some embodiments.

Step s202 comprises RCA agent obtaining input data. In one embodiment, the input data comprises time-series KPI data for each network node of system 100 (e.g., each gNB). RCA agent 190 can collect this KPI data from the gNBs themselves, as shown in FIG. 1, or from a central repository.

As an example, the KPI data RCA agent 190 collects for any given gNB may comprise a set of KPI vectors KPIₖ for k=1 . . . K, for the gNB, where each KPI vector contains a set of KPI values for a particular KPI. For example, if K=3, then KPI₁ is vector containing T RSRP values, where T specifies the number of time slots, KPI₂ is vector containing T RSRQ values, and KPI₃ is vector containing T SINR values. More generally, KPIₖ==kpiₖ[t] for t=1 to T. Such a set of KPI vectors exists for each node.

Step s204 comprises the RCA agent 190 using the KPI data to obtain, for each node, a set of feature vectors for the node, each feature vector corresponding to one of the T time slots. For example, for each time slot t, performance of each network node can be represented by a feature vector of KPIs of length I (which is also known as a “feature” associated to the network node at a time slot t). As an example, assuming K=3, the feature vector for a node for the 2nd time slot (i.e., t=2), which is denoted Fₜ₌₂, contains the following KPI values: [kpi₁[2], kpi₂[2], kpi₃[2]]. More generally: Fₜ=kpiₖ[t] for k=1 to K. As an illustrative example, if KPI₁=[4, 7, 33, . . . ], KPI₂=[3, 9, 2, . . . ], and KPI₃=[−44, 16, 12, . . . ], then Fₜ₌₀=[4, 3, −44], Fₜ₌₂=[7, 9, 16], and Fₜ₌₃=[33, 2, −12].

Step s206 comprises the RCA agent using the feature vectors for each network node to obtain graph information (a.k.a., “relationship information”), such as, for example, an adjacency matrix, that indicates relationships between the network nodes (e.g., the relationship information, for each network node, indicates the other network nodes to which the node is logically connected and a weight value for the connection). In one embodiment, the feature vectors for each network node are fed into a neural network (NN) proposed by reference [15] and this NN generates an adjacency matrix with edges and weights for building a graph. The constructed graph-structured input data with nodes and feature vectors is self-contained and informative enough for training a GNN.

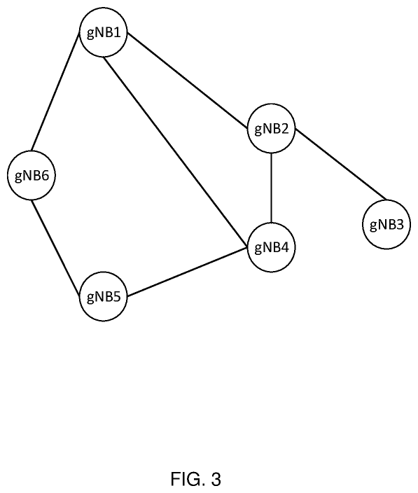

FIG. 3 illustrates an example graph 300 that can be created based on the graph information (a.k.a., relationship data) obtained in step s206. Graph 300 indicates logical connections between gNBs of communication system 100 as specified by the adjacency matrix produced by the NN. This adjacency matrix plus the feature vectors for each gNB is the input data that is used to analyze and explore root causes when some parts of the network go wrong.

Step s208 comprises network node classification. The RCA agent 190 takes the feature vectors obtained from step s204 and the graph information obtained from step s206 (e.g., the adjacency matrix) and inputs these to a GNN 192. GNN 192 functions to identify network nodes as potential root cause nodes and identify network nodes as potential victim nodes (i.e., network nodes that suffered a problem caused by a root cause node).

For instance, based on edge information in the adjacency matrix, the structure of a graph can be determined and features are assigned to each node in the graph (each node in the graph represents one of the network nodes in system 100). More specifically, as each node in the graph corresponds to one of the network nodes of system 100, the feature assigned to a node in the graph is the set of features vectors obtained for the network node corresponding to the node in the graph. As explained below, the GNN 192 uses the input to generate an embedding for each node and then use the embedding for a node to determine whether the node should be classified as a candidate “root cause node” or a candidate “victim node.”

Step s210 comprises propagation path analysis. An assumption made in this stage is that a node gets affected by the others if and only if they are along a same path (a set of links). For example, an observed victim node has to be along a same path as a potential root cause node.

In step s210, for each node classified as a candidate root cause node, RCA agent 190 utilizes the graph information obtained in step s204 to decide whether to indicate that the candidate root cause node is a predicted root cause node. For example, if the graph information indicates that the candidate root cause node is not logically connected to any of the candidate victim nodes, then RCA agent 190 will not indicate that the candidate root cause node is a predicted root cause node, otherwise RCA agent 190 will indicate that the candidate root cause node is a predicted root cause node.

Similarly, for each node classified as a candidate victim node, RCA agent 190 utilizes the graph information obtained in step s204 to decide whether to indicate that the candidate victim node is a predicted victim node. For example, if the graph information indicates that the candidate victim node is not logically connected to any of the candidate root cause nodes, then RCA agent 190 will not indicate that the candidate victim node is a predicted victim node, otherwise RCA agent 190 will indicate that the candidate victim node is a predicted victim node.

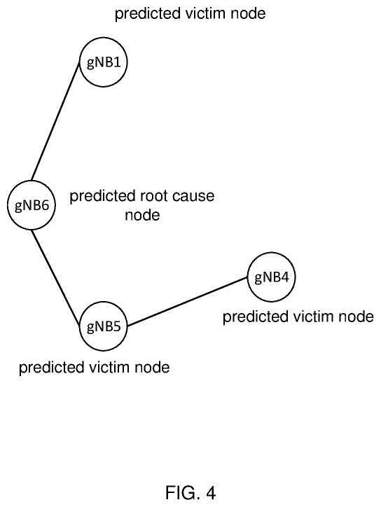

Step s212 comprises outputting the predictions. For example, if RCA agent 190 determines to indicate that a particular candidate root cause node is a predicted root cause node, then RCA agent will output root cause information that identifies the particular node as a predicted root cause node and will output victim information identifying the predicted victim nodes that are logically connected to the predicted root cause node. For each predicted victim node, the victim information may identify the node (or nodes) to which the victim node is directly connected. For example, a first victim node may be directly connected to the root cause node and a second victim node may be directly connected to the first victim node (in this way the second victim node is indirectly connected to the predicted root cause node). FIG. 4 graphically illustrates the output information produced by RCA agent 190. In the example shown, the output information indicates that gNB6 is the predicted root cause node, and the output information further indicates that predicted victim nodes gNB1 and gNB5 are directly connected to the predicted root cause node while the predicted victim node gNB4 is directly connected to gNB5.

Step s214 comprises predication evaluation. In this step, RCA agent 190 compares a set of observed victim nodes with a set of predicted victim nodes. The observed victim nodes along a path are encoded into a binary vector vₒ∈R^{N}. The predicted victim nodes along a path are encoded into the other binary vector vₚ∈R^{N}. The similarity between these two vectors is calculated by Jaccard index to evaluate the score. If the vectors are not sufficiently similar, then this means that the GNN 192 should be re-trained.

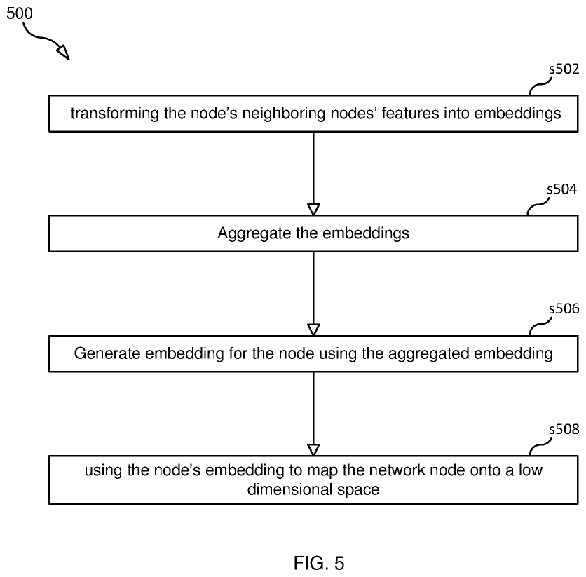

FIG. 5 illustrates steps performed by GNN 192 for each network node, according to some embodiments.

Step s502 comprises transforming the node's neighboring nodes' features into embeddings. For example, step s502 may comprise inputting the feature vectors for the node's neighboring nodes into a transformer neural network (NN) that transforms each feature vector into an embedding (another vector) by tunable weight values within the NN's hidden layers.

Step s504 comprises, aggregating the embeddings from the neighboring nodes. For example, if an embedding for a first neighbor node is [3,5] and the embedding for a second neighbor node is [6,1], then the aggregated embedding (AE) is [9,6] (i.e., [3+6, 5+1])

Step s506 comprises using the aggregated embedding to generate an embedding for the network node. For example, the aggregated embedding and a feature vector (FV) for the network node are concatenated to form an input vector (IV) and this input vector (IV) is then fed into the transformer NN which then produces an embedding for the network node.

During the training of the GNN 192, it fine-tunes the weights that output optimal embeddings.

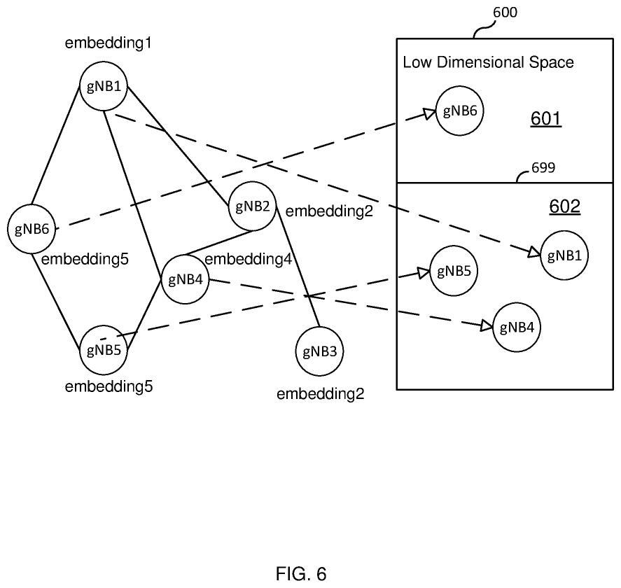

Step s508 comprises GNN 192 using the node's embeddings to map the network node onto a low dimensional space for separating the potential root causes (sources) and the other victim nodes (symptoms) as illustrated in FIG. 6. FIG. 6 shows that each node in the graph has embeddings (e.g., the embedding obtained in step s506) and that one or more nodes can be mapped to a low dimensional space 600, which, as shown by line 699, can be divided into a first low dimensional sub-space 601 and a second low dimensional sub-space 602. The sub-space to which a node is mapped indicates the classification for the node. In this example, each node mapped to sub-space 601 is classified as a candidate root cause node, while each node mapped to sub-space 602 is classified as a candidate victim node.

Accordingly, GNN 192 can classify some nodes as candidate root cause nodes and classify some nodes as candidate victim nodes. As explained above with respect to step s210, RCA agent 190 uses the graph information to determine whether or not to indicate that a candidate root cause node is a predicted root cause node and uses the graph information to determine whether or not to indicate that a candidate victim node is a predicted victim node.

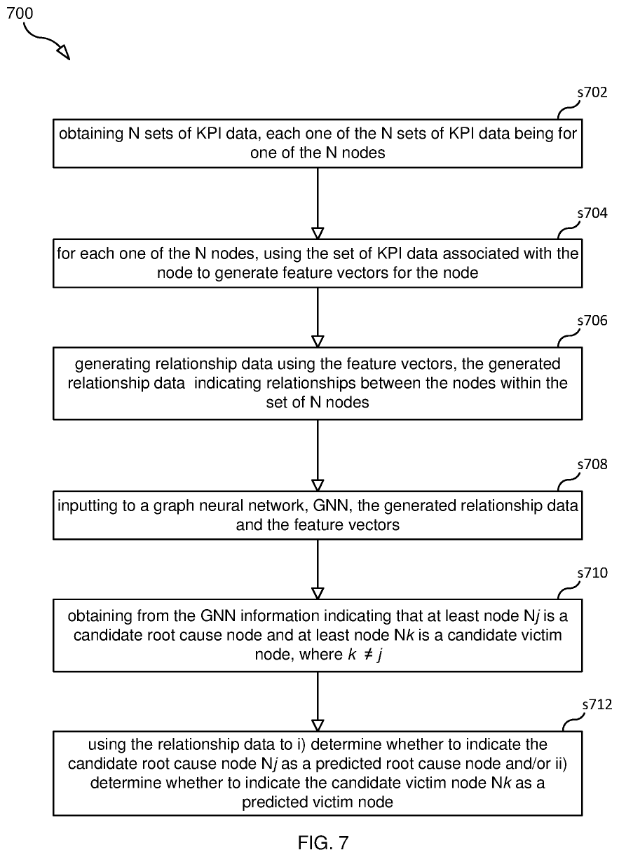

FIG. 7 is a flowchart illustrating a process 700 for root cause analysis in a network (e.g., system 100) comprising a set of nodes Ni for i=1 to N, where N>2. Process 700 may be performed by RCA agent 190 and may begin in step s702.

Step s702 comprises obtaining N sets of KPI data, each one of the N sets of KPI data being for one of the N nodes. Each set of KPI data may comprise M KPI vectors (e.g., a RSRP vector of RSRP values, an RSRQ vector of RSRQ values, etc.).

Step s704 comprises, for each one of the N nodes, using the set of KPI data associated with the node to generate feature vectors for the node. For example, T features vectors are generated, one for each of the T time slots. In some embodiments each set of KPI data comprises M KPI vectors, and each feature vector is of length K, where K<M.

Step s706 comprises generating relationship data using the feature vectors, the generated relationship data indicating relationships between the nodes within the set of N nodes. In one embodiment, this step corresponds to step s206. Thus, in one embodiment, the feature vectors for each network node are fed into an NN that then generates an adjacency matrix with edges and weights for building a graph.

Step s708 comprises inputting to a graph neural network, GNN, the generated relationship data and the feature vectors.

Step s710 comprises obtaining from the GNN information indicating that at least node Nj is a candidate root cause node and at least node Nk is a candidate victim node, where k≠j.

Step s712 comprises using the relationship data to i) determine whether to indicate the candidate root cause node Nj as a predicted root cause node and/or ii) determine whether to indicate the candidate victim node Nk as a predicted victim node.

In some embodiments the relationship data comprises an N×N adjacency matrix, where each value within the matrix is associated with a different pair of nodes and indicates whether the nodes are determined to be logically connected to each other.

In some embodiments the GNN is configured to use the feature vectors and the relationship data to generate an embedding for each one of the N nodes.

In some embodiments, for each one of the N nodes, the GNN is configured to use a node's embedding to classify the node as either a candidate root cause node, RCN, or a candidate victim node, VN.

In some embodiments the GNN is configured to generate an embedding for a given one of the N nodes, Nx, by performing a process that includes: determining a pair of nodes Ny, Nz where each node of the pair is indicated as being logically connected to node Nx; and calculating an aggregated embedding, AE, by calculating AE=Ey+Ez, where Ey is an embedding for node Ny and Ez is an embedding for node Nz.

In some embodiments the process also includes creating an input vector by concatenating FV and the aggregated embedding, wherein FV is a feature vector for node Nx, and feeding the input vector into a neural network to produce an embedding for node Nx.

In some embodiments, using the relationship data to determine whether to indicate the candidate victim node as a predicted victim node comprises determining whether the relationship data indicates that the candidate victim node is logically connected to the candidate root cause node either directly or indirectly via one or more other candidate victim nodes.

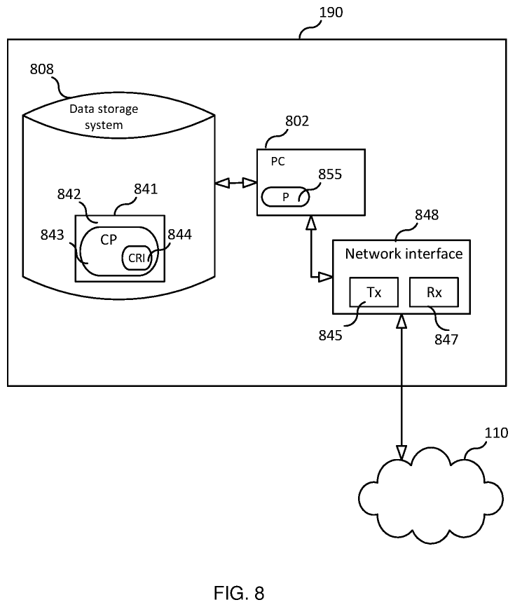

FIG. 8 is a block diagram of RCA agent 190, according to some embodiments. As shown in FIG. 8, RCA agent 190 may comprise: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., RCA agent 190 may be a distributed computing apparatus); at least one network interface 848 comprising a transmitter (Tx) 845 and a receiver (Rx) 847 for enabling RCA agent 190 to transmit data to and receive data from other nodes connected to a network 110 (e.g., an Internet Protocol (IP) network) to which network interface 848 is connected (directly or indirectly) (e.g., network interface 848 may be wirelessly connected to the network 110, in which case network interface 848 is connected to an antenna arrangement); and a storage unit (a.k.a., “data storage system”) 808, which may include one or more non-volatile storage devices and/or one or more volatile storage devices. In an alternative embodiment the network interface 848 may be connected to the network 110 over a wired connection, for example over an optical fiber or a copper cable. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes RCA agent 190 to perform steps of the methods described herein (e.g., steps described herein with reference to one or more of the flow charts). In other embodiments, RCA agent 190 may be configured to perform steps of the methods described herein without the need for code. That is, for example, PC 802 may consist merely of one or more ASICs. Hence, the features of the embodiments described herein may be implemented in hardware and/or software.

### SUMMARY OF VARIOUS EMBODIMENTS

A1. A method for root cause analysis in a network comprising a set of nodes Ni for i=1 to N, where N>2, the method comprising: obtaining N sets of KPI data, each one of the N sets of KPI data being for one of the N nodes; for each one of the N nodes, using the set of KPI data associated with the node to generate feature vectors for the node; generating relationship data using the feature vectors, the generated relationship data indicating relationships between the nodes within the set of N nodes; inputting to a graph neural network, GNN, the generated relationship data and the feature vectors; obtaining from the GNN information indicating that at least node Nj is a candidate root cause node and at least node Nk is a candidate victim node, where k≠j; and using the relationship data to i) determine whether to indicate the candidate root cause node Nj as a predicted root cause node and/or ii) determine whether to indicate the candidate victim node Nk as a predicted victim node.

A2. The method of embodiment A1, wherein the relationship data comprises an N×N adjacency matrix, where each value within the matrix is associated with a different pair of nodes and indicates whether the nodes are determined to be logically connected to each other.

A3. The method of embodiment A1 or A2, wherein the GNN is configured to use the features vectors and the relationship data to generate an embedding for each one of the N nodes.

A4. The method of embodiment A3, wherein, for each one of the N nodes, the GNN is configured to use a node's embedding to classify the node as either a candidate root cause node, RCN, or a candidate victim node, VN.

A5. The method of embodiment A3 or A4, wherein the GNN is configured to generate an embedding for a given one of the N nodes, Nx, by performing a process that includes: determining a pair of nodes Ny, Nz where each node of the pair is indicated as being logically connected to node Nx; and calculating an aggregated embedding, AE, by calculating AE=Ey+Ez, where Ey is an embedding for node Ny and Ez is an embedding for node Nz.

A6. The method of embodiment A5, further comprising creating an input vector by concatenating a feature vector for node Nx and the aggregated embedding, and feeding the input vector into a neural network to produce an embedding for node Nx.

A7. The method of any one of embodiments A1-A6, wherein each set of KPI data comprises M KPI vectors; and each feature vector is of length K, where K<M.

A8. The method of any one of embodiments A1-A7, wherein using the relationship data to determine whether to indicate the candidate victim node as a predicted victim node comprises determining whether the relationship data indicates that the candidate victim node is logically connected to the candidate root cause node either directly or indirectly via one or more other candidate victim nodes.

B1. A computer program (843) comprising instructions (844) which when executed by processing circuitry (802) of root cause analysis, RCA, agent (190) causes the RCA agent (190) to perform the method of any one of the above embodiments.

B2. A carrier containing the computer program of embodiment B1, wherein the carrier is one of an electronic signal, an optical signal, a radio signal, and a computer readable storage medium (842).

C1. A root cause analysis, RCA, agent (190), the RCA agent (190) being configured to perform a process comprising: obtaining N sets of KPI data, each one of the N sets of KPI data being for one of the N nodes; for each one of the N nodes, using the set of KPI data associated with the node to generate feature vectors for the node; generating relationship data using the feature vectors, the generated relationship data indicating relationships between the nodes within the set of N nodes; inputting to a graph neural network, GNN, the generated relationship data and the feature vectors; obtaining from the GNN information indicating that at least node Nj is a candidate root cause node and at least node Nk is a candidate victim node, where k≠j; and using the relationship data to i) determine whether to indicate the candidate root cause node Nj as a predicted root cause node and/or ii) determine whether to indicate the candidate victim node Nk as a predicted victim node.

C2. The RCA agent of embodiment C1, wherein the RCA agent is further configured to perform the method of any one of embodiments A2-A8.

D1. A root cause analysis, RCA, agent (190), the RCA agent (190) comprising: a data storage system (808); and processing circuitry (802), wherein the RCA agent (190) is configured to perform any one of the methods disclosed herein.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for root cause analysis in a network comprising a set of nodes Ni for i=1 to N, where N>2, the method comprising:
obtaining N sets of key performance indicator (KPI) data, each one of the N sets of KPI data being for one of the N nodes;
for each one of the N nodes, using the set of KPI data associated with the node to generate feature vectors for the node;
generating relationship data using the feature vectors, the generated relationship data indicating relationships between the nodes within the set of N nodes;
inputting to a graph neural network (GNN) the generated relationship data and the feature vectors;
obtaining from the GNN information indicating that at least node Nj is a candidate root cause node and at least node Nk is a candidate victim node, where k≠j; and
using the relationship data to i) determine whether to indicate the candidate root cause node Nj as a predicted root cause node and/or ii) determine whether to indicate the candidate victim node Nk as a predicted victim node.

2. The method of claim 1, wherein
the relationship data comprises an N×N adjacency matrix, and
each value within the matrix is associated with a different pair of nodes and indicates whether the nodes are determined to be logically connected to each other.

3. The method of claim 1, wherein the GNN is configured to use the features vectors and the relationship data to generate an embedding for each one of the N nodes.

4. The method of claim 3, wherein, for each one of the N nodes, the GNN is configured to use a node's embedding to classify the node as either a candidate root cause node (RCN) or a candidate victim nodes (VN).

5. The method of claim 3, wherein the GNN is configured to generate an embedding for a given one of the N nodes, Nx, by performing a process that includes:
determining a pair of nodes Ny, Nz where each node of the pair is indicated as being logically connected to node Nx; and
calculating an aggregated embedding, AE, by calculating AE=Ey+Ez, where Ey is an embedding for node Ny and Ez is an embedding for node Nz.

6. The method of claim 5, wherein the method further comprises:
creating an input vector by concatenating a feature vector for node Nx and the aggregated embedding; and
feeding the input vector into a neural network to produce an embedding for node Nx.

7. The method of claim 1, wherein
each set of KPI data comprises M KPI vectors; and
each feature vector is of length K, where K<M.

8. The method of claim 1, wherein using the relationship data to determine whether to indicate the candidate victim node as a predicted victim node comprises determining whether the relationship data indicates that the candidate victim node is logically connected to the candidate root cause node either directly or indirectly via one or more other candidate victim nodes.

9. A non-transitory computer readable storage medium storing a computer program comprising instructions which when executed by processing circuitry of root cause analysis (RCA) agent causes the RCA agent to perform the method of claim 1.

10. (canceled)

11. A root cause analysis (RCA) agent, the RCA agent comprising:
a data storage system; and
processing circuitry, wherein the RCA agent is configured to perform a method comprising:
obtaining N sets of key performance indicator (KP)I data, each one of the N sets of KPI data being for one of the N nodes;
for each one of the N nodes, using the set of KPI data associated with the node to generate feature vectors for the node;
generating relationship data using the feature vectors, the generated relationship data indicating relationships between the nodes within the set of N nodes;
inputting to a graph neural network (GNN) the generated relationship data and the feature vectors;
obtaining from the GNN information indicating that at least node Nj is a candidate root cause node and at least node Nk is a candidate victim node, where k≠j; and
using the relationship data to i) determine whether to indicate the candidate root cause node Nj as a predicted root cause node and/or ii) determine whether to indicate the candidate victim node Nk as a predicted victim node.

12. The RCA agent of claim 11, wherein
the relationship data comprises an N×N adjacency matrix, and
each value within the matrix is associated with a different pair of nodes and indicates whether the nodes are determined to be logically connected to each other.

13. The RCA agent of claim 11, wherein the GNN is configured to use the features vectors and the relationship data to generate an embedding for each one of the N nodes.

14. The RCA agent of claim 13, wherein, for each one of the N nodes, the GNN is configured to use a node's embedding to classify the node as either a candidate root cause node (RCN) or a candidate victim node (VN).

15. The RCA agent of claim 13, wherein the GNN is configured to generate an embedding for a given one of the N nodes, Nx, by performing a process that includes:
determining a pair of nodes Ny, Nz where each node of the pair is indicated as being logically connected to node Nx; and
calculating an aggregated embedding, AE, by calculating AE=Ey+Ez, where Ey is an embedding for node Ny and Ez is an embedding for node Nz.

16. The RCA agent of claim 15, wherein the RCA agent is further configured to:
create an input vector by concatenating a feature vector for node Nx and the aggregated embedding; and
feed the input vector into a neural network (NN) to produce an embedding for node Nx.

17. The RCA agent of claim 11, wherein
each set of KPI data comprises M KPI vectors; and
each feature vector is of length K, where K<M.

18. The RCA agent of claim 11, wherein using the relationship data to determine whether to indicate the candidate victim node as a predicted victim node comprises determining whether the relationship data indicates that the candidate victim node is logically connected to the candidate root cause node either directly or indirectly via one or more other candidate victim nodes.

19. (canceled)
